(19) United States
(12) Patent Application Publication
(10) Pub. No.: US 2002/0088745 A1
(43) Pub. Date: Jul. 11, 2002

(54) Portable water purifying unit

(76) Inventor: Michael M. Barlow, Bartlett, IL (US)

Correspondence Address: Daniel N. Christus, Wallenstein & Wagner, Ltd., 311 South Wacker Drive, 53rd Floor, Chicago, IL, 60606-6630, US

(21) Appl. No.: 09/758,752

(22) Filed: Jan. 11, 2001

(51) Int. Cl. C02F 1/00

(52) U.S. Cl. 210/266

(57) ABSTRACT

A portable water purifying unit for treating microbiologically contaminated water. The water purifying unit includes a main body portion that is a generally hollow, preferably cylindrical container. A water purifying medium, preferably a halogenated resin, is contained within the generally hollow container. A giardia filter is placed downstream from the water purifying medium, and the giardia filter may be incorporated into a filter medium. The intake end of the invention may comprise either a fine mesh screen placed at the bottom of the generally hollow container, or a plurality of holes placed into the bottom of the otherwise sealed end of that container. The mouthpiece of the water purifying unit may comprise a pull-push type closure. When the closure is pulled, the closure is in an opened position, and water may be drawn through the water purifying unit. In contrast, when pushed, the closure is in the closed position, sealing the top of the unit. A protective overcap covers the working elements of the push-pull type closure, and that overcap can contain additional giardia filter elements.

### TECHNICAL FIELD

This patent relates generally to a unit for purifying water that may be easily transported in the pocket, purse, backpack, or portfolio of the user.

### BACKGROUND OF THE INVENTION

Portable water purifying units are known in the art, and have also been described in United States patents. For example, one portable water purifying unit has been described in U.S. Pat. No. 4,298,475 (“the '475 patent”), issued to William J Gartner on Nov. 3, 1981, and entitled “Water Purifying System.” The '475 patent is directed to a water purifying unit that comprises an elongated tube having a filtering agent, a bactericidal agent, and an adsorbent material, all retained within a tube. The user's mouth provides suction at the top end of the unit, and this suction draws water through the unit. As the water moves through the unit, foreign material is filtered out and the water is purified prior to its ingestion.

An example of a commercial water purifying unit is the unit manufactured by Water One, Inc., Hanover Park, Ill. 60103. This unit is cylindrical, and is used in the same manner as the water purifying unit of the '475 patent. Again, water is drawn through the unit when the user supplies suction from the mouth. The intake or lower end of the purifying unit includes a separate giardia filter cap. The cap is made of plastic, and a replaceable, flat giardia filter removes the giardia cyst on contact. Next to the separate giardia filter cap, and at the bottom of the long cylindrical body, a primary inlet filter is provided to remove suspended particulate matter. This primary inlet filter occupies only about 5% of the length of the cylindrical main body of the water purifying unit.

Above the primary inlet filter is a so-called Stage 1 purifying medium. This medium is a resin, typically a halogenated resin, which kills microorganisms. Suitable resins include the iodine-containing resins such as those described in U.S. Pat. Nos. 3,932,665, issued to Lambert and Fina on Dec. 2, 1975; 3,817,860, issued to Lambert and Fina on Jun. 18, 1974, and 4,420,590, issued to William J. Gartner on Dec. 13, 1983. This Stage 1 purifying medium, i.e., the halogenated resin, occupies approximately 28% of the length of the main body of the water purifying unit.

Above the Stage 1 purifying medium is a secondary filter material, similar to the primary inlet filter, to remove additional particulates. Like the primary inlet filter, this secondary filter material occupies approximately 5% of the length of the main body of the water purifying unit.

Above the secondary filter is a Stage 2 purifying medium of carbon, which removes impurities and makes the taste of the water more palatable. The Stage 2 purifying medium occupies approximately 50% of the length of the main body of the water purifying unit.

Above the Stage 2 purifying medium is a tertiary, or final filter material, similar to the primary and secondary inlet filters, to remove most of any remaining particulates. Like the primary and second inlet filters, this final filter material occupies approximately 5% of the length of the main body of the water purifying unit.

Completing the water purifying unit, and attached to the top of the main cylindrical body of that unit, is a mouthpiece through which the user applies suction and draws the water.

While the above-described water purifying unit is generally suitable, it has some drawbacks. First, the giardia filter is located adjacent the water inlet side at the bottom of the unit. Accordingly, this filter acts as the initial means of removing particulates. As a result of its location, the giardia filter in this water purifying unit has a tendency to clog more quickly, and thereby require more frequent changing. Frequent changing for the giardia filter at the bottom of this water purifying unit is undesirable. This is because the giardia filter may become clogged before the filter loses its ability to remove the giardia cyst.

### SUMMARY OF THE INVENTION

The invention is a portable water purifying unit for treating microbiologically contaminated water. The water purifying unit includes a main body portion that is a generally hollow container. A preferred embodiment of this main body portion is a cylindrical, generally hollow container. A most preferred embodiment is a main body portion made from a blown plastic bottle preform.

Within the generally hollow container are a number of elements. One element is a water purifying medium contained within the generally hollow container. Preferably, the water purifying medium is a resin. The most preferred resin is a halogenated resin, such as an iodine-containing resin. Optionally, a silver carbon material is blended with the resin or separately contained by a dividing filter.

One of the novel aspects of the invention is a giardia filter placed downstream from the water purifying medium. In one preferred embodiment of the invention, the giardia filter is incorporated into the mouthpiece.

The intake end of the present invention is preferably directed to one of two arrangements. First, the intake end of the invention may comprise a fine mesh screen placed at the bottom of the generally hollow container. Preferably, the fine mesh screen is made of stainless steel. Second, the intake end of the invention may comprise a plurality of holes placed into the bottom of the otherwise sealed end of the generally hollow container. In this type of embodiment, one may also place a fine mesh screen within, and near the bottom of, the generally hollow container.

In the most preferred embodiment, the water purifying unit may include a mouthpiece that is made of a pull-push type closure. When the closure is pulled, the closure is in an opened position. When in this open position, water may be drawn through the portable water purifying unit. In contrast, when pushed, the closure is in the closed position; as a result, the top of the unit is sealed.

The portable water purifying unit may include an overcap that covers the working elements of the push-pull type closure. The portable water purifying unit may also include additional giardia filter elements, to replace the original filter elements when they have lost their efficacy.

These additional giardia filter elements may be stored within the overcap. Alternatively, these additional giardia filter elements may be enclosed within a receptacle. The receptacle may then be tethered to an exterior portion of the portable water purifying unit.

### BRIEF DESCRIPTION OF THE DRAWINGS

FIG. 1 is a perspective view of one embodiment of the present invention, including a flat fine mesh screen placed at an otherwise open bottom of the generally hollow container.

FIG. 2 is a partially exploded view of the embodiment of FIG. 1.

FIG. 3 is a cross-sectional view taken along lines 3-3 of FIG. 1.

FIG. 4 is a perspective view of a second embodiment of the present invention, including a plurality of holes placed in the otherwise closed, bottom end of the generally hollow container, and showing the push-pull type closure in its open position.

FIG. 5 is a cross-sectional view of a portion of the embodiment of FIG. 4, taken along lines 5-5 of FIG. 4, and showing a fine mesh screen placed within and near the bottom of the generally hollow container.

FIG. 6 is a view of the invention of FIG. 4, with the push-pull type closure in its closed position.

FIG. 7 is a view of another embodiment of the invention, where the water purifying medium and the silver carbon material are separated within the main body portion of the water purifying unit.

### DETAILED DESCRIPTION

This invention is susceptible of embodiment in many different forms. The drawings show and the specification describes in detail a preferred embodiment of the invention. It will be understood that the present disclosure is to be considered as an example of the principles of the invention. The disclosure is not intended to limit the broad aspect of the invention to the illustrated and described embodiments.

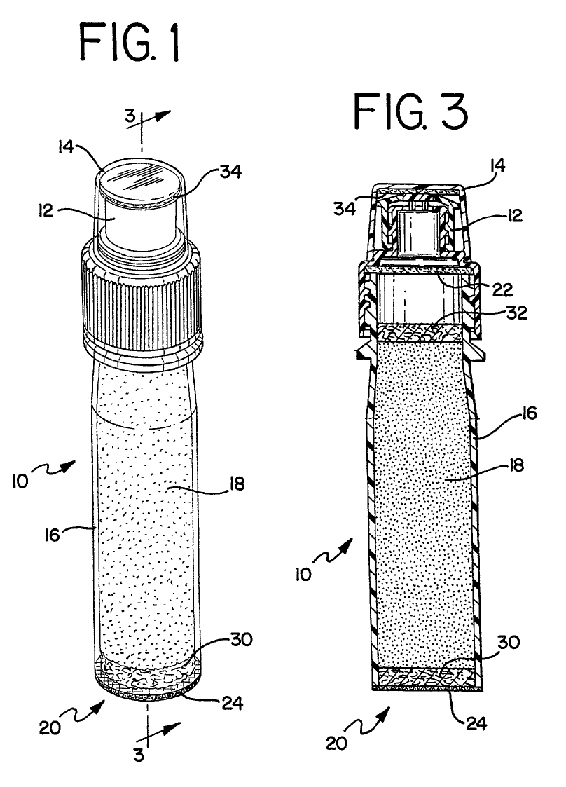

As may best be seen in FIG. 1, the invention is a portable water purifying unit 10 for treating microbiologically contaminated water. The microbiologically contaminated water is treated by the present unit 10, which water could contain bacteria and water-borne viruses. This unit 10 is used by an individual in any environment, but most typically in the outdoors. In the outdoors, one may need to obtain water from a source such as a river, lake, or stream. The user may not, however, have confidence in the purity of the water within that source. Accordingly, the user draws water through the water purifying unit 10 of FIGS. 1-6 by placing his mouth over the closure or mouthpiece 12, and sipping water through the unit 10, just as one would sip water through a straw. As will be explained below, as the water is drawn through the water purifying unit 10, deleterious substances are either killed or removed.

It is preferred that the mouthpiece 12 is a closure, i.e., a conventional pull-push type closure. These push-pull closures 12 are of the type used for reopening and reclosing sports drinks. Closures of the type used in this invention are described in U.S. Pat. Nos. 6,135,329 (“the '329 patent”), issued to Stoneberg et al. on Oct. 24, 2000, and 5,465,876 (“the '876 patent”), issued to Crisci on Nov. 14, 1995. These kinds of closures are also available from Creative Packaging Corporation of Buffalo Grove, Ill., the assignee of the '329 patent. Preferably, the threaded closure 12 of the present invention has a diameter of 28 millimeters or 33 millimeters.

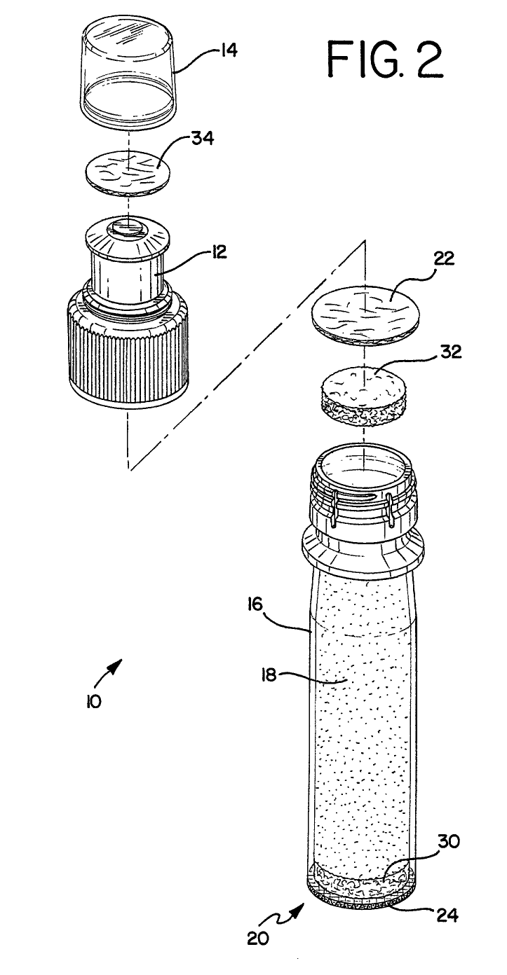

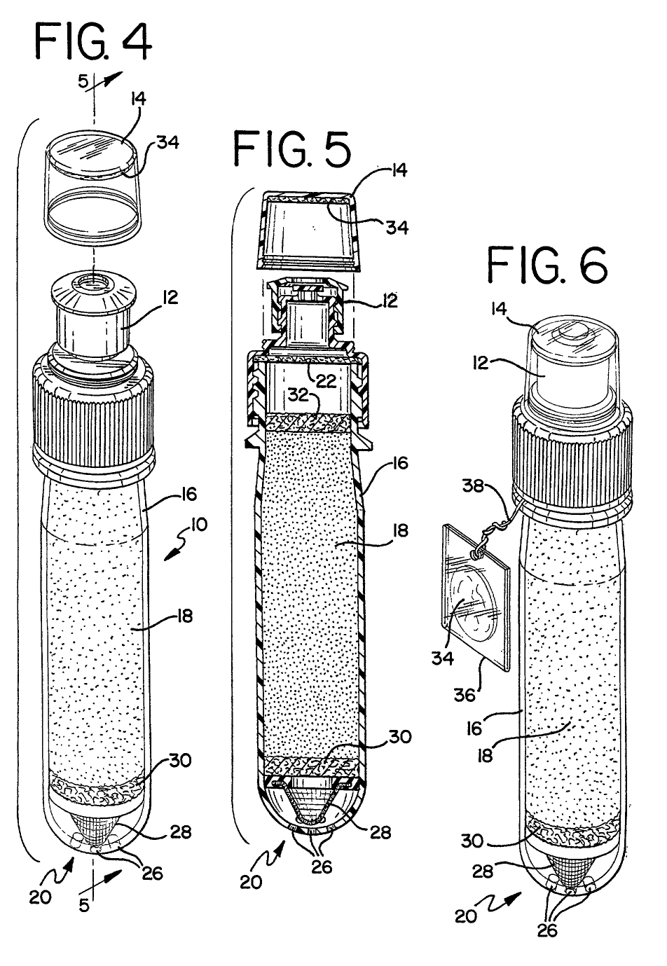

When the closure 12 is pulled, as may best be seen in FIGS. 4 and 5 of the present application or in FIG. 2 of the '876 patent, the closure 12 is in an upright, opened position. When in this opened position, water may be drawn through the portable water purifying unit 10.

In contrast, when this push-pull closure 12 is pushed, as shown in FIGS. 1-3 and 6 of the present application or in FIG. 1 of the '876 patent, the closure 12 is in a lowered, closed position. When the push-pull closure 12 is in this lowered, closed position, the top of the water purifying unit 10 is sealed. When sealed, neither water nor air can be drawn through the water purifying unit 10. Moreover, with the push-pull closure 12 in this closed position, air cannot as readily pass through the water purifying unit 10, and the water purifying medium contained within the water purifying unit 10 remains wet for a longer period of time.

The push-pull type closure 12 of the present invention is advantageous over the mouthpieces of the prior art. Prior art mouthpieces were normally open devices, which could not be closed except with an additional, overlying and separate element. In contrast, the present push-pull type closure 12 operates as a sealing cap when in the pushed position of FIGS. 1-3 and 6, and also operates as an opening and mouthpiece when in the pulled position of FIGS. 4 and 5.

The portable water purifying unit 10 may include an overcap 14 that covers the moving or working elements of the push-pull type closure 12. This overcap 14 protects the push-pull type closure 12 from contaminants, and from structural damage due to impact or the like. As will be explained below, the overcap 14 can also be used to house replacement or spare filter elements.

FIG. 2 is an exploded view of the water purifying unit 10 of FIG. 1. The water purifying unit 10 includes a main body portion 16 that is a generally hollow container. The main body portion 16 needs to be hollow to contain the elements that are used to filter and purify the water passing through the water purifying unit 10. The most preferred shape for this main body portion 16 is the cylindrical, generally hollow container shown in FIG. 2. A most preferred element for the main body portion 16 is a threaded, plastic blow molded bottle preform. The most preferred threaded, plastic bottle preform is made of polyethylene terephthalate (PET). Such threaded, blow molded plastic bottle preforms are available from Encon of Dayton, Ohio, Catalog No. P-1536. The use of PET, combined with the larger diameter of the main body portion 16, makes the present water purifying unit 10 much less susceptible to breakage than the prior art units that were typically made of acrylobutyl styrene (ABS). The main body portion 16 of the present invention has an internal diameter of up to nineteen (19) millimeters, compared to an internal diameter of approximately ten (10) millimeters for the ABS main body portions of the above-described prior art water purifiers. An additional benefit of the larger diameter of the present water purifying unit 10 is that there is lower back pressure through the unit 10, resulting in a lowering of the amount of suction necessary for the user to draw water through the unit 10.

Within the main body portion 16 that makes up the generally hollow container are a number of elements. One element within the main body portion 16 is a water purifying medium 18. Preferably, the water purifying medium 18 is a resin. The most preferred resin is a halogenated resin, such as an iodine-containing resin. Suitable resins include the iodine-containing resins such as those described in U.S. Pat. Nos. 3,932,665, issued to Lambert and Fina on Dec. 2, 1975; 3,817,860, issued to Lambert and Fina on Jun. 18, 1974, and 4,420,590, issued to William J. Gartner on Dec. 13, 1983.

Optionally, a silver carbon material may be blended with the resin, or separated. This silver carbon material inhibits the growth of bacteria, and also reduces the amount of halogens that are eluted into the water as that water passes through the water purifying unit 10. A suitable silver carbon material may be obtained from Bamebey & Sutcliffe Columbus, Ohio, as Catalog No. 989. A suitable blend of the resin and silver carbon material is one (1) part (wt.) resin and 1-3 parts (wt.) silver carbon material. The resin or resin/carbon silver combination 18 extends through about 104 millimeters, or about 80%, of the 130 millimeter length of the main body portion 16 of the embodiment of FIGS. 4-6.

One of the most significant novel aspects of the invention is the placement of a giardia filter downstream from the water purifying medium. Because the water inlet 20 or intake end is at the bottom of the water purifying units 10 shown in FIGS. 1-6, water moves downstream through the unit 10 as it moves from the bottom of the unit towards the top of the unit. As noted above, in the prior art units, the giardia filter is located adjacent the inlet side at the bottom of the unit. Because of this location, this prior art giardia filter acts as an initial means of removing particulates. Accordingly, the giardia filter in this prior art water purifying unit has a tendency to clog more quickly, and thus requires more frequent changing. Frequent changing for the giardia filter at the bottom of this water purifying unit is undesirable. This is because frequent replacement slightly increases the cost of using the water purifying unit. A further disadvantage in such frequent replacement is that these giardia filters may become clogged before the filters lose their ability to remove the giardia cyst.

In contrast, the present giardia filter is placed downstream from the water purifying medium 18. In this preferred embodiment, the giardia filter is placed on a flat, disc-shaped filter 22, and that filter 22 is placed within a cavity at the underside of the push-pull type closure 12, as shown in FIGS. 2, 3, and 5. The filter 22 is made of a glass micro fiber grade paper medium or equivalent with a micron size of 2 to 3 microns. The material for this filter 22 is obtained from Whatman International of Maidstone, United Kingdom, as Part No. F216-16. This filter includes the means to filter the giardia cyst.

One of two structures may appear at the intake end 20 of the water purifying unit 10 of the present invention. First, as may be seen in FIGS. 1-3, the intake end 20 of the invention may comprise a fine mesh screen 24 placed at the bottom of the main body portion 16 of the generally hollow container. In this embodiment, the hemispherically shaped bottom is cut away from the main body portion 16 to create a flat peripheral surface onto which the fine mesh screen 24 is secured. Preferably, the fine mesh screen 24 is made of stainless steel. Suitable fine mesh screen (400 by 400) may be obtained from McMaster-Carr of Elmhurst, Ill., as Catalog No. 9319T-6.

Second, as may be seen in the embodiment of FIGS. 4-6, the intake end 20 of the water purifying unit 10 may instead include a plurality of holes 26 placed into the bottom of the otherwise sealed end of the generally hollow container, i.e., the main body portion 16. As may also be seen in FIGS. 4-6, this embodiment may also include an auxiliary fine mesh screen 28 placed within, and near the bottom of, the main body portion 16.

Fibrous filter element 30 and an optional fibrous element 32 are placed near the bottom and top, respectively, of the main body portion 16. These fibrous filter elements 30 and 32 are made from polypropylene, which may be obtained from the Porex Corporation of Atlanta, Ga., as a custom blend. A preferred filter element 30 will remove particulates as small as about 150 microns, while a preferred filter element 32 will remove particulates as small as about 75 microns. These fibrous filter elements are preferably inert to the color changes that can result from contact with halogens in the water treated with the halogenated resin 18. The fibrous filter element 30 extends through about 10 millimeters, or about 8%, of the 130 millimeter length of the main body portion 16. The optional fibrous filter element 32 extends through about 7 millimeters, or about 5%, of the 130 millimeter length of the main body portion 16.

The portable water purifying unit 10 of the invention may also include additional replacement giardia elements 34. These are identical to, and intended as replacements of, the original filter elements 22. As may be seen in FIGS. 1-5, these additional giardia elements 34 may be stored within the overcap 14.

Alternatively, as may be seen in FIG. 6, one or more of these additional giardia filter elements 34 may be enclosed within a recloseable receptacle 36. The receptacle 36 may then be tethered, or otherwise secured to the exterior of the portable water purifying unit 10 with a twist tie or wire 38.

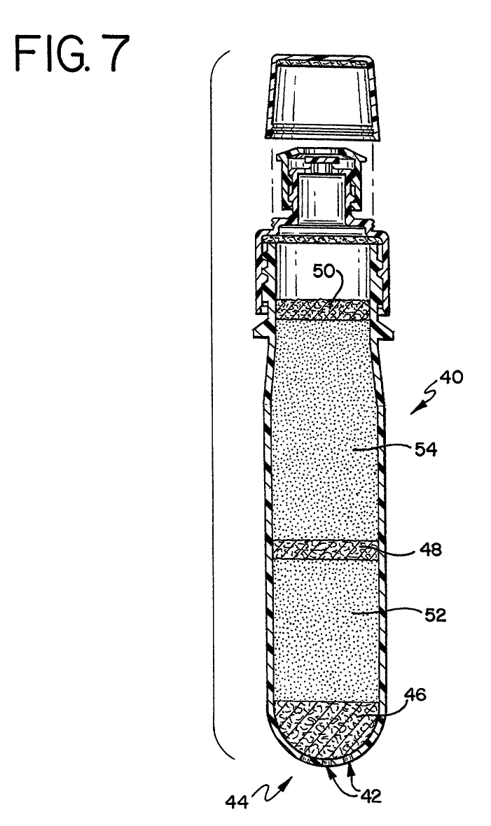

FIG. 7 shows a slightly different embodiment. In this embodiment, the water purifying unit 40 has a plurality of holes 42 at the bottom water inlet end 44 of the unit 40. Three separate fibrous filter elements 46, 48, and 50 may be found within the unit 40. Fibrous filter element 46 fills in the entire hemispherical lower end of the unit 40, and separates the holes 42 from the water purifying resin 52. In this embodiment, however, the water purifying resin 52 is not blended with the silver carbon material 54. Rather, the silver carbon material 54 is a separate component, occupying its own space within the unit 40. Fibrous filter element 48 separates the water purifying resin 52 from the silver carbon material 54.

It will be understood that a shrink wrap label (not shown) may be secured about the perimeter of the main body portion 16. This shrink wrap label includes marketing information, operating instructions, and the name of the product's manufacturer.

From the above, it will be understood that the portable water purifying unit 10 has many significant advantages over prior art portable water purifying units. First and most significantly, the placement of the giardia filter at a downstream location results in the initial removal of the particulates by upstream elements, including both the water purifying medium and one or more fibrous filter elements. This reduces the particulate load on the giardia filter or any other element that contains the giardia filter, prolonging the life of the filter. This in turn decreases the frequency of giardia filter replacement, and thereby lowers the long-term cost of using the portable water purifying unit 10.

Prior art portable water purifiers, such as those described in the “Background of the Invention” section above, had relatively narrow body portion diameters. Particularly, the body sections of prior art purifiers had diameters of about ten (10) millimeters. In contrast, the purifier of the present invention has a preferred diameter of about nineteen (19) millimeters. As noted above, the advantage of the larger diameter of the present water purifying unit 10 is that there is lower back pressure through the unit 10, resulting in a lowering of the amount of suction necessary for the user to draw water through the unit 10, as compared to prior art units. This greater internal diameter also enables additional amounts of the water purifying medium 18 to be used in the present water purifying unit 10. This additional medium 18 extends the life of the water purifying unit 10, by enabling greater volumes of water to be drawn through the unit 10 before exhaustion of the resin or other medium 18. This additional medium 18 also provides additional particulate pre-filtering capabilities.

Moreover, as noted above, the wider body 16 of the present invention and the fewer filters, as compared to the prior art units, lowers the back pressure in the present water purifying unit 10. In addition to lowering the back pressure in the unit 10 during normal use, the wider body 16 and fewer filters jointly facilitate drying of the unit 10 after use. Such drying is aided by blowing air through the mouthpiece 12 in a reverse direction, i.e, in a direction opposite the normal direction of flow of water through the unit 10. In this way, excess water is removed through the nominal water inlet 20, i.e., through the fine mesh screen 24 of the embodiment of FIGS. 1-3 or through the holes 26 of the embodiment of FIGS. 4-6.

Furthermore, because excess water is blown out of the bottom of the unit 10 of the present invention, there is no need for a separate, polypropylene sleeve that encloses the prior art unit. This separate sleeve acts as a receptacle for any retained water that can drip from the prior art unit over a prolonged period after that unit has been used.

The push-pull type closure 12 is advantageous for many reasons. To the inventor's knowledge, no prior art water purifying unit ever included such a closure 12. This closure 12 can act as both a mouthpiece and a closure, depending upon whether the closure is in its pulled, open position (FIGS. 4 and 5), or its pushed, closed position (FIGS. 1-3 and 6), respectively.

The portable water purifying unit of the invention includes a generally hollow container that is unbreakable in normal use. Moreover, the generally hollow container is resistant to bending, crushing, or discoloration.

Specific embodiments have been illustrated and described. Numerous modifications are possible, without significantly departing from the spirit of the invention. Therefore, the scope of protection is only limited by the scope of the accompanying claims.

I claim:

1. A portable water purifying unit for treating microbiologically contaminated water, said water purifying unit comprising (a) a generally hollow container; (b) a water purifying medium contained within said generally hollow container; and (c) a giardia cyst reduction filter placed downstream from said water purifying medium.

2. The portable water purifying unit of claim 1, wherein said water purifying medium is a resin.

3. The portable water purifying unit of claim 2, wherein said water purifying resin is a halogenated resin.

4. The portable water purifying unit of claim 3, wherein said halogenated resin is an iodine-containing resin.

5. The portable water-purifying unit of claim 1, further comprising a fine mesh screen placed at the bottom of said generally hollow container.

6. The portable water-purifying unit of claim 1, further comprising a plurality of holes placed into the bottom of said generally hollow container.

7. The portable water purifying unit of claim 1, further comprising a mouthpiece including a pull-push type closure, wherein water may be drawn through the open water purifying unit when said closure is pulled, and wherein the top of the water purifying unit is closed when said closure is pushed.

8. The portable water purifying unit of claim 5, wherein said fine mesh screen is made of stainless steel.

9. The portable water purifying unit of claim 6, further comprising a fine mesh screen placed within and near the bottom of said generally hollow container.

10. The portable water purifying unit of claim 1, wherein said generally hollow container is made from a bottle preform.

11. The portable water purifying unit of claim 1, wherein a silver carbon material is blended with said purifying medium.

12. The portable water purifying unit of claim 1, wherein a silver carbon material is separated from said purifying medium.

13. The portable water purifying unit of claim 7, wherein said push-pull type closure includes an overcap.

14. The portable water purifying unit of claim 11, further comprising additional giardia cyst reduction elements .

15. The portable water purifying unit of claim 12, wherein said additional giardia filter elements are stored within said overcap.

16. The portable water purifying unit of claim 12, wherein said additional giardia filter elements are enclosed within a receptacle, and wherein said receptacle is secured to the exterior of said portable water purifying unit.

17. The portable water purifying unit of claim 1, wherein a silver carbon material is blended with said water purifying medium.

18. The portable water purifying unit of claim 1, wherein said generally hollow container is unbreakable in normal use.

19. The portable water purifying unit of claim 1, wherein said generally hollow container is resistant to bending, crushing or discoloration.

20. A portable water purifying unit for treating microbiologically contaminated water, said water purifying unit comprising (a) a generally hollow container; (b) a water purifying medium contained within said generally hollow container; (c) a silver carbon material within said generally hollow container, but separated from said water purifying medium; and (d) a giardia cyst reduction filter placed downstream from said water purifying medium.

21. The portable water purifying unit of claim 20, further comprising a plurality of holes at the bottom water inlet end of the unit.

22. The portable water purifying unit of claim 20,wherein a fibrous filter element separates the water purifying resin from the silver carbon material.
